(19) United States
(12) Patent Application Publication
(10) Pub. No.: US 2017/0068937 A1
(43) Pub. Date: Mar. 9, 2017

(54) MOBILE PAYMENT METHOD AND SYSTEM

(71) Applicants: Michiel Laurens Jakob Liezenberg, Aerdenhout (NL); Hidde Sytse Lycklama à Lycklama, Delft (NL); Joris Cornelius Oudejans, Delft (NL)

(72) Inventors: Michiel Laurens Jakob Liezenberg, Aerdenhout (NL); Hidde Sytse Lycklama à Lycklama, Delft (NL); Joris Cornelius Oudejans, Delft (NL)

(73) Assignee: VLINDERSTORM BV, Delft (NL)

(21) Appl. No.: 14/846,995

(22) Filed: Sep. 7, 2015

(51) Int. Cl. G06Q 20/06; G06Q 20/32; G06K 7/14

(52) U.S. Cl. CPC G06Q 20/0655; G06K 7/1417; G06Q 20/3276; G06Q 20/322

(57) ABSTRACT

Methods and an associated system for end-to-end secured payments between users and other users or merchants, using only touch gestures and with no exchange of payment identifiers, credentials, or authorization codes include 1) a computer-implemented method for end-to-end secured payments between users and other users or merchants, using only touch gestures and with no entry, storage, nor exchange of regulated payment system identifiers, credentials, or authorization codes; 2) a non-transitory computer readable storage medium encoded with programming for end-to-end secured payments between users and other users or merchants using only touch gestures, with no entry, storage, nor exchange of regulated payment system identifiers, credentials, or authorization codes; and 3) a system for end-to-end secured payments between users and other users or merchants using only touch gestures, with no entry, storage, nor exchange of regulated payment system identifiers, credentials, or authorization codes.

### FIELD OF THE INVENTION

The technology described herein relates generally to systems and methods for payment. More specifically, this technology relates to systems and methods that utilize an application for a mobile phone connected to an electronic network and for mobile payment using crypto currency and without any alpha-numeric payment data entry.

### BACKGROUND OF THE INVENTION

Various payment methods and systems are well known in the art to perform payments using regulated currencies in regulated payment networks, also in relation to the mobile phone. Such methods and systems always require the user to enter the other user's payment system identifier, the amount and an authorization code (e.g. PIN) to initiate and authorize a payment, all typically in alpha-numeric characters. Entering such information is time consuming, error-prone and securing the exchange of the payment system identifier and authorization code in particular imposes all kinds of regulatory requirements on such solutions, as a result of using regulated currencies and payment networks.

Therefore a need exists for a payment method which enables end-to-end secured payments, but does not require any alpha-numeric data entry by the user to initiate and authorize such a payment and eliminates the regulatory requirements simply by removing the need to exchange any data to which regulation applies.

The method and system includes a simple application used with a smartphone that is capable of connecting to other users, and initiating and authorizing a payment to any such user with a few simple gestures. The application, that can be downloaded from app stores, links the application on a mobile phone uniquely and securely to a user's virtual account in a simple activation process in which basic user information is entered and instantly verified, and a PIN code is set for future access to the activated application.

An objective of the present invention is to provide a payment method and system that is secure and intuitive to use for both proximity and remote peer-to-peer and consumer-to-business transactions.

A further objective of the present invention is to provide a payment method and system that does not require any alpha-numeric input by the user to initiate and authorize a payment to another user.

A further objective of the present invention is to provide a payment method and system that uses a crypto currency for settling payment transactions.

These and other objectives will be apparent to one of ordinary skill in the art based upon the following written description.

### BRIEF SUMMARY OF THE INVENTION

In various exemplary embodiments, the technology described herein provides systems and methods that utilize an application for a mobile phone connected to an electronic network and for mobile payment using crypto currency and without any alpha-numeric payment data entry.

In one exemplary embodiment, the technology described herein provides a computer-implemented method for end-to-end secured payments between users and other users or merchants, using only touch gestures and with no entry, storage, nor exchange of regulated payment system identifiers, credentials, or authorization codes. The method includes: providing a service provider platform having a computer, a database, and a mobile application, wherein the mobile application is accessible and downloadable over an electronic network; downloading and utilizing, by a first user, the mobile application on a portable computing device having a processor, a display, a data storage area, and a wireless communication technology; activating and configuring the mobile application for use by the first user; discovering a second user; presenting an icon, representing the second user, to the first user through the display of the mobile application; selecting, by the first user, the second user to whom payment is to be made; creating, by the first user, and using only touch gestures and with no entry, storage, nor exchange of regulated payment system identifiers, credentials, or authorization codes, a payment transaction to be made to the second user; transmitting to the service provider platform the payment transaction for authorization; debiting an account of the second user the payment transaction; and notifying the first user, by the service provider platform, that the payment transaction is complete.

In at least one embodiment, the computer-implemented method also includes: activating the mobile application for the first user, after downloading; contacting, by the first user, the service provider platform via the electronic network; creating a uniquely associated user account with an identification code; assigning, by the service provider platform, an account identification code to the mobile application of the first user; entering a mobile phone number and an email address for the first user; verifying the entered mobile phone number and email address through an independent messaging channel; setting a plurality of permissions for the mobile application to access system services; creating a code, by the first user, for personal identification, and of which only a cryptographic equivalent is exchanged and stored; and transmitting all data from the mobile application of the first user to the service provider platform to store in an account in the database.

In at least one embodiment, the computer-implemented method further includes: configuring the mobile application for the first user; and setting a user profile for the first user including a display name and an avatar for visual communication to a second user during the discovering step.

In at least one embodiment, the computer-implemented method also includes: setting a display currency; and converting all crypto currency values used by the mobile application into the display currency.

In at least one embodiment, the computer-implemented method further includes: maintaining a virtual account for the first user at the service provider platform; maintaining a crypto currency account with a crypto currency exchange; maintaining a crypto currency balance with service provider platform; and linking the virtual account and the crypto currency account.

In at least one embodiment, the computer-implemented method also includes utilizing proximity detection technology and wireless communication technology.

In at least one embodiment of the computer-implemented method, the step of discovering a second user includes: utilizing account QR codes; and scanning by the first user an account QR code of the second user.

In at least one embodiment of the computer-implemented method, the step of discovering a second user includes: utilizing an address book containing contacts; and selecting by the first user a contact of the second user.

In at least one embodiment of the computer-implemented method the second user is a merchant.

In another exemplary embodiment, the technology described herein provides a non-transitory computer readable storage medium encoded with programming for end-to-end secured payments between users and other users or merchants using only touch gestures, with no entry, storage, nor exchange of regulated payment system identifiers, credentials, or authorization codes, that when executed by a processor perform the steps: providing a service provider platform having a computer, a database, and a mobile application, wherein the mobile application is accessible and downloadable over an electronic network; downloading and utilizing, by a first user, the mobile application on a portable computing device having a processor, a display, a data storage area, and a wireless communication technology; activating and configuring the mobile application for use by the first user; discovering a second user; presenting an icon, representing the second user, to the first user through the display of the mobile application; selecting, by the first user, the second user to whom payment is to be made; creating, by the first user, and using only touch gestures and with no entry, storage, nor exchange of regulated payment system identifiers, credentials, or authorization codes, a payment transaction to be made to the second user; transmitting to the service provider platform the payment transaction for authorization; debiting an account of the second user the payment transaction; and notifying the first user, by the service provider platform, that the payment transaction is complete.

In at least one embodiment, the non-transitory computer readable storage medium also includes these processor steps: activating the mobile application for the first user, after downloading; contacting, by the first user, the service provider platform via the electronic network; creating a uniquely associated user account with an identification code; assigning, by the service provider platform, an account identification code to the mobile application of the first user; entering a mobile phone number and an email address for the first user; verifying the entered mobile phone number and email address through an independent messaging channel; setting a plurality of permissions for the mobile application to access system services; creating a code, by the first user, for personal identification, and of which only a cryptographic equivalent is exchanged and stored; and transmitting all data from the mobile application of the first user to the service provider platform to store in an account in the database.

In at least one embodiment, the non-transitory computer readable storage medium also includes these processor steps: configuring the mobile application for the first user; and setting a user profile for the first user including a display name and an avatar for visual communication to a second user during the discovering step.

In at least one embodiment, the non-transitory computer readable storage medium also includes these processor steps: setting a display currency; and converting all crypto currency values used by the mobile application into the display currency.

In at least one embodiment, the non-transitory computer readable storage medium also includes these processor steps: maintaining a virtual account for the first user at the service provider platform; maintaining a crypto currency account with a crypto currency exchange; maintaining a crypto currency balance with service provider platform; and linking the virtual account and the crypto currency account.

In at least one embodiment of the non-transitory computer readable storage medium, the processor step of discovering a second user also includes utilizing proximity detection technology and wireless communication technology.

In at least one embodiment of the non-transitory computer readable storage medium, the processor step of discovering a second user also includes: utilizing account QR codes; and scanning by the first user an account QR code of the second user.

In at least one embodiment of the non-transitory computer readable storage medium, the processor step of discovering a second user also includes: utilizing an address book containing contacts; and selecting by the first user a contact of the second user.

In at least one embodiment of the non-transitory computer readable storage medium, the second user is a merchant.

In yet another exemplary embodiment, the technology described herein provides a system for end-to-end secured payments between users and other users or merchants using only touch gestures, with no entry, storage, nor exchange of regulated payment system identifiers, credentials, or authorization codes. The system includes: a service provider platform having a computer, a database, and a mobile application, wherein the mobile application is accessible and downloadable over an electronic network; a portable computing device having a processor, a display, a data storage area, and a wireless communication technology, configured to download the mobile application for utilization by a first user; wherein the processor is configured to run the mobile application in communication with the service provider platform and performs the steps including: activating and configuring the mobile application for use by the first user; discovering a second user; presenting an icon, representing the second user, to the first user through the display of the mobile application; selecting, by the first user, the second user to whom payment is to be made; creating, by the first user, and using only touch gestures and with no entry, storage, nor exchange of regulated payment system identifiers, credentials, or authorization codes, a payment transaction to be made to the second user; transmitting to the service provider platform the payment transaction for authorization; debiting an account of the second user the payment transaction; and notifying the first user, by the service provider platform, that the payment transaction is complete.

In at least one embodiment, the system also includes: wherein the processor is configured to run the mobile application and performs the steps further including: activating the mobile application for the first user, after downloading; contacting, by the first user, the service provider platform via the electronic network; creating a uniquely associated user account with an identification code; assigning, by the service provider platform, an account identification code to the mobile application of the first user; entering a mobile phone number and an email address for the first user; verifying the entered mobile phone number and email address through an independent messaging channel; setting a plurality of permissions for the mobile application to access system services; creating a code, by the first user, for personal identification, and of which only a cryptographic equivalent is exchanged and stored; and transmitting all data from the mobile application of the first user to the service provider platform to store in an account in the database.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram depicting system entities and relationships between the entities for the system that utilizes an application for a mobile phone connected to an electronic network and mobile payment using crypto currency and without any alpha-numeric payment data entry, according to an embodiment of the technology described herein;

FIG. 2 is a schematic diagram depicting a user app screen in which a current balance in shown in Bitcoin and no profile picture set, according to an embodiment of the technology described herein;

FIG. 3 is a schematic diagram depicting a user app screen in which a display currency is set to [symbol] and profile picture set, according to an embodiment of the technology described herein;

FIG. 4 is a schematic diagram depicting a user app screen in which additional avatars are utilized, according to an embodiment of the technology described herein;

FIG. 5 is a schematic diagram depicting a user app screen in which an initial coin is depicted, according to an embodiment of the technology described herein;

FIG. 6 is a schematic diagram depicting a user app screen in which a coin is being set to a specific amount, according to an embodiment of the technology described herein;

FIG. 7 is a schematic diagram depicting a user app screen in which payment to a specific user for a specific amount is set, according to an embodiment of the technology described herein;

FIG. 8 is a schematic diagram depicting a user app screen in which payment to another user is made, according to an embodiment of the technology described herein;

FIG. 9 is a schematic diagram depicting a user app screen in which payment delivery (debit) to another user, according to an embodiment of the technology described herein; and

FIG. 10 is a schematic diagram depicting another user app careen showing payment delivery (credit) from a user, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides systems and methods that utilize an application for a mobile phone connected to an electronic network and for mobile payment using crypto currency and without any alpha-numeric payment data entry.

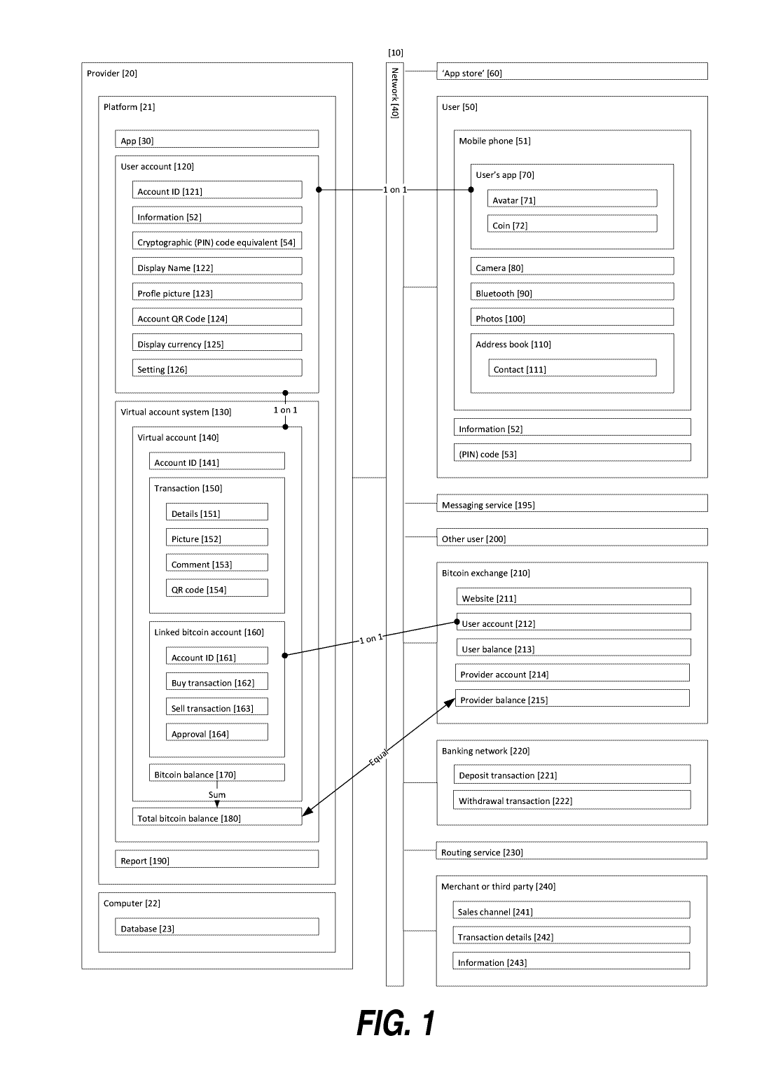

Referring to FIG. 1, the mobile payment system 10 of the provider's 20 platform 21 includes a computer 22 having a database 23 and an application 30 that can be accessed and downloaded over an electronic network 40 by a user 50 through the user's 50 mobile phone 51. The application 30 is provided through the provider's 20 platform 21 or a third party's app store 60.

The user 50 can use the activated application 70 on its mobile phone 51 to pay other users 200 or merchants 240 in proximity or remotely, using crypto currency to settle the payment transactions 150 and a crypto currency exchange 210 to exchange crypto currency with any supported display currency 125 in platform 21 via the banking network 220.

Application Activation and Account Creations

To use the application 30, the user 50 first downloads the application 30 via the electronic network 40 to the mobile phone 51. Once downloaded, the user 50 opens the application 70 on the user's 50 mobile phone 51. Upon first open, the application 70 contacts the provider's 20 platform 21 via the electronic network 40 upon which a uniquely associated user account 120 with an account identification code 121 and its virtual account 140 with an account identification code 141 in the virtual account system 130 are created in the database 23, and the account identification code 121 is assigned to the application 70 on the user's 50 phone 51. Only after this has happened successfully can the user 50 continue activation of the application 70 on the user's 50 mobile phone 51, and only from the mobile phone 51, providing information 52 that includes entry of the mobile phone number and email address and verification thereof through independent messaging channels 195, and the setting of permissions for the application 70 to access system services of phone 51. The user 50 then creates a code 53 such as a personal identification number of which only a cryptographic equivalent 54 is exchanged and stored. After activation, the user 50 may also provide other personal information 52 such as its name or bank account number depending upon services used. All data from the application 70 on the user's 50 phone 51 is transmitted via the electronic network 40 to the provider's 20 platform 21 and stored in the account 120 in the database 23.

Once the application 70 on the user's 50 mobile phone 51 has been successfully activated, the user 50 can use application 70 on its mobile phone 51. A first use would be to configure application 70. The user 50 can set a profile including a display name 122, a profile picture 123 selected from the photos 100 on their phone 51 to create the user's 50 avatar 71 that will be visible to other user's 200 when their application's 70 discover each other. Also the user 50 can set a display currency 125 converting all the crypto currency values used in the application 70 into the display currency's 125 equivalent based on the current exchange rate for both currencies. Other settings 126 are also available for more personalization. The actual values in the virtual account 140 however, always remain in crypto currency.

Merchants 240 can also create an account 120 on the provider's 20 platform 21 by providing information 243, such as their area of business, legal entity name, legal entity identifiers, legal representatives, business name, address, phone number, email address, website, bank account number, etc. The merchant account 120 activation process will typically include a verification of this information 243 before the account 120 can be used for consumer-to-business payments 150. After that, it functions just like any other user account 120.

Balance, Deposits and Withdrawals

To make a payment 150 to another user 200 or merchant 240, the user 50 needs to have crypto currency balance 170 in its virtual account 140 related to application 70. This balance 170 can be obtained in two ways. Either another user 200 makes a payment 150 to user 50 with a coin 72, in which case the value of coin 72 is debited from the other user's 200 virtual account 140 balance 170 and credited to the user's 50 virtual account 140 balance 170 instantly.

Another method for a user 50 to increase its virtual account 140 balance 170 is to deposit crypto currency with a buy transaction 162 that is initiated and authorized within application 70, after which the virtual account 140 is credited instantly with the purchased amount. In a similar manner, a user 50 can withdraw crypto currency from its virtual account 140 balance 170 with a sell transaction 163 that is initiated and authorized within application 70, after which the virtual account 140 is debited instantly with the sold amount.

All buy 162 and sell 163 transactions are executed through the user's 50 linked crypto currency account 160 registered in database 23 with an account identifier 161 and directly associated with the user's account 212 at a crypto currency exchange provider 210, which is provisioned upon the user's 50 first use of currency exchange for a buy 162 or sell 163 through application 70.

A buy transaction 162 initiated, approved 164 with a PIN code 53 and authorized by a user 50 from within application 70 for an amount of crypto currency at the current exchange rate, initiates a deposit transaction 221 from the user's 50 bank in the banking network 220 to the crypto currency exchange provider 210 of the equivalent amount of funds. When the funds are received on the bank account of the crypto currency exchange 210, it transfers the purchased amount of crypto currency from its own crypto currency account to the user's 50 account 212, and then immediately transfers the same amount of crypto currency to the provider's crypto currency account 214 at the crypto currency exchange 210 on the user's 50 behalf. When the provider 20 receives the crypto currency of the user 50 in its crypto currency account 214 at the crypto currency exchange provider 210, it credits the received amount of crypto currency to the user's 50 virtual account 140 in the virtual account system 130. The net change of the balance 213 on the user's 50 account at the crypto currency exchange 210 is zero.

A sell transaction 163 initiated, approved 164 with a PIN code 53 and authorized by a user 50 from within application 70 for an amount of crypto currency at the current exchange rate, instantly debits the sold amount of crypto currency on the user's 50 virtual account 140 and initiates a transfer of the amount of crypto currency from the provider's 20 crypto currency account 214 to the user's 50 account 212 at the crypto currency provider 210, who then immediately transfers the same amount of crypto currency to its own crypto currency account on the user's 50 behalf. Next the crypto currency exchange 210 initiates a withdrawal transaction 222 from its bank in the banking network to the bank account number the user 50 entered for the sell transaction 163. The net change of the balance 213 on the user's 50 account at the crypto currency exchange 210 is zero.

Users 50 can optionally activate and access their accounts 212 at the crypto currency exchange 210 through the website 211 of the crypto currency exchange 210 to view all transactions 162 and 163 on their accounts 212 executed on their behalf, and may use it for crypto currency transactions independent of the provider's 20 platform 21 and without use of application 70.

The balance 215 of the provider's 20 crypto currency account 214 at the crypto currency exchange 210 must always be equal to the total balance 180 of the virtual account system 130 in the provider's platform 21, which is the sum of all the crypto currency balances 170 of all the virtual accounts 140 in virtual account system 130. This will be monitored with reports 190.

User Discovery and Connections

Users 50 can discover and connect to other users 200 and/or merchants 240 to make payments 150 in three ways.

The first automatic discovery mechanism between the users' 50 mobile phones 51 is made using Bluetooth 90 low energy (BLE), which may be combined with PM technology for added security, but other proximity technologies such as WiFi or NFC may also be used. The BLE 90 connections are automatically established as soon as a user opens its application 70 on its phone 51. The application 70 detects the broadcasted account IDs 121 of the other users 200 and submits all the received account IDs 121 through the network 40 to the provider's 20 platform 21. The application 70 receives the display name 122 and profile picture 123 of each other user 200 and presents them in the application 70 as individual avatars 71. This mechanism can also be used by merchants 240 for consumer-to-business payments 150 using e.g. Bluetooth beacons.

A second connection mechanism between the user's 50 mobile phones 51 is made using the mobile phone's 51 camera 80 from within application 70. The user 50 manually scans the account QR code 124 in the application 70 of another user 200. The application 70 submits the scanned account QR code 124 through the network 40 to the provider's 20 platform 21. The application 70 receives the display name 122 and profile picture 123 of the other user 200 and presents them in the application 70 as an avatar 71. This mechanism can also be used by merchants 240 for consumer-to-business payments 150 by presenting their account QR code 124 in their sales channels 241. Alternatively, a merchant 240 can also present a transaction specific QR code 154 in their sales channels 241. For this the merchant 240 submits the transaction details 242 through the network 40 to the provider's 20 platform 21, either directly or indirectly through a routing service 230, upon which the provider 20 prepares a transaction 150 and generates a transaction QR code 154 relating to it which the merchant 240 presents in its sales channels 241. The user 50 manually scans the transaction QR code 154 in the channel 241 of the merchant 240 using the mobile phone's 51 camera 80 from within application 70. The application 70 submits the scanned QR code 154 through the network 40 to the provider's 20 platform 21. The application 70 receives the display name 122 and profile picture 123 of the merchant 240 and the transaction amount which it uses to present in the application 70 the merchant's 240 avatar 71 and a coin 72 set exactly to the transaction 150 amount, if the user's 50 balance 170 is sufficient.

A third mechanism uses the address book 110 on the user's 50 mobile phone 51. Simply by selecting a contact 111 in the address book 110, user 50 creates an avatar 71 for contact 111 that is presented in application 70. Based on the mobile number of the contact 111 in the address book 110, the platform 21 determines if the contact is already a user 50 or not. If so, the avatar 71 shows the display name 122 and profile picture 123 of the user 50. If not, than the avatar may show placeholder information using the contact's 111 information in the address book 110.

Payment

All of the preceding steps and processes are required to create the conditions for end-to-end secured payments 150 between users 50 and other users 200 or merchants 240, without the regulatory requirements being applicable, using only (touch) gestures.

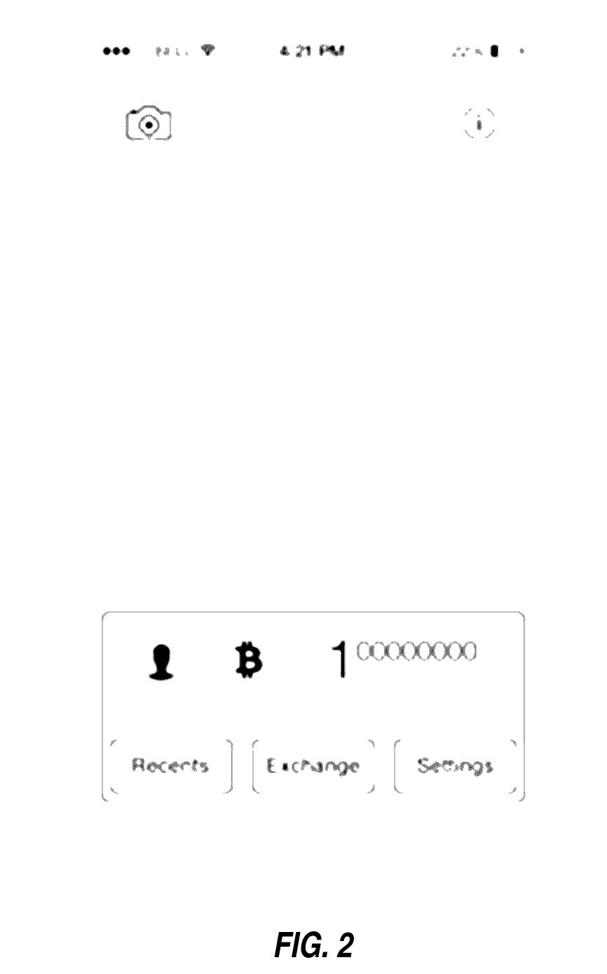

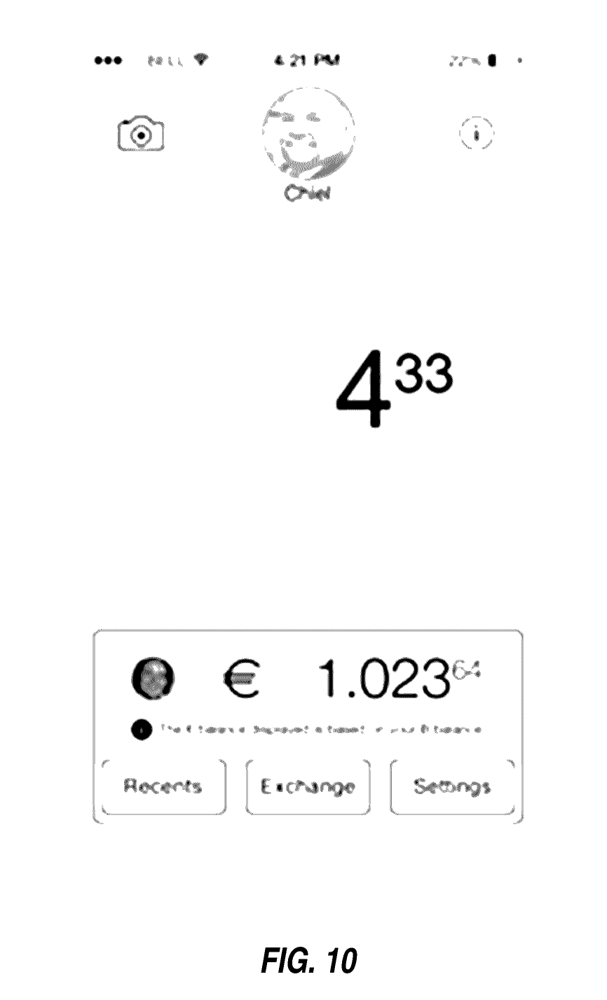

FIGS. 2-9 illustrate the user 50 experience of making a payment 150 to another user 200 or a merchant 240, either in proximity or remote, after discovery and connection as set out, without any alpha-numeric data entry by user 50. FIG. 10 illustrates the other user 200 experience of receiving a payment 150 from user 50.

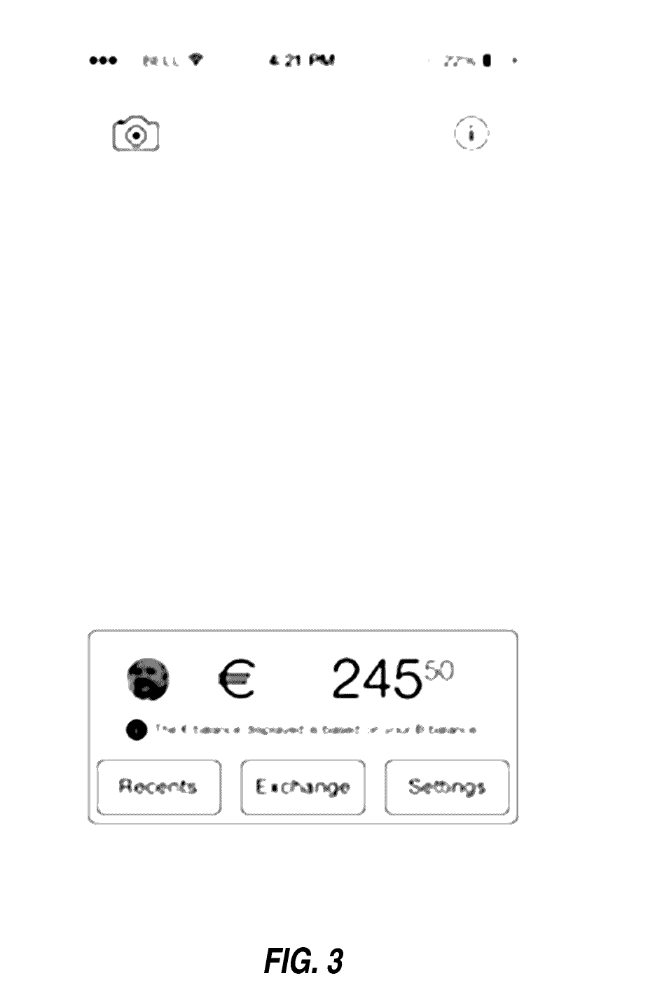

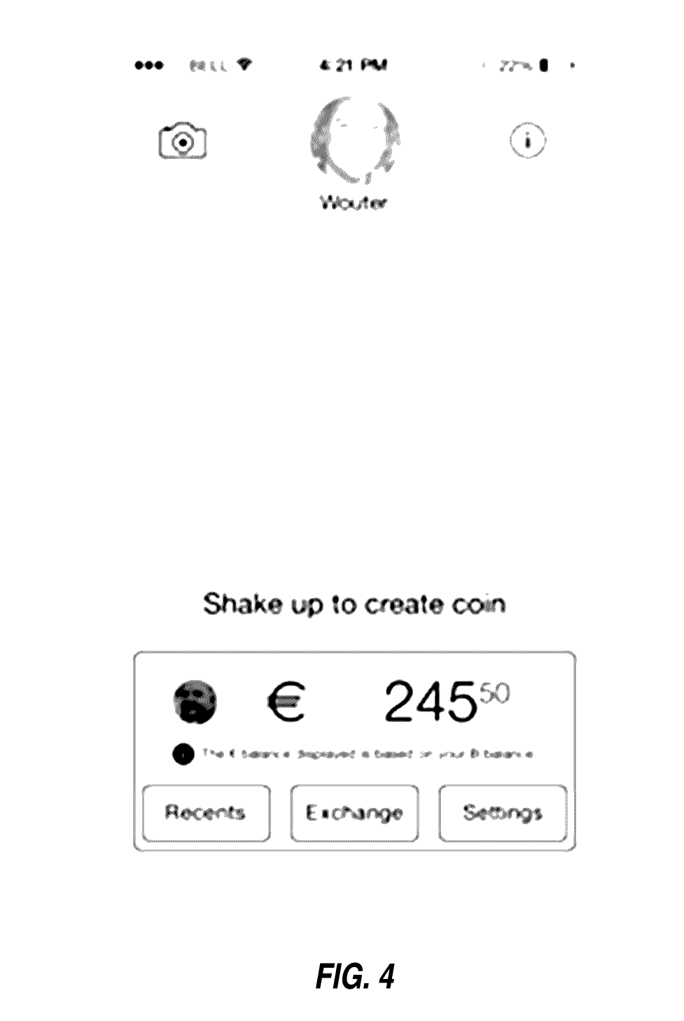

FIG. 2 shows the application 70 in the start-up state, with the user's 50 virtual account balance 170 in crypto currency. FIG. 3 shows the application 70 in the same state, but now set to the [symbol] display currency 125 by user 50. FIG. 4 illustrates the discovery by and presentation in the user's 50 application 70 of other users 200 or merchants 240 that a payment 150 can be made to. Display names 122 and profile pictures 123 are clearly visible in the other users' 200 avatars 71, so the right one can be selected by user 50 to pay to.

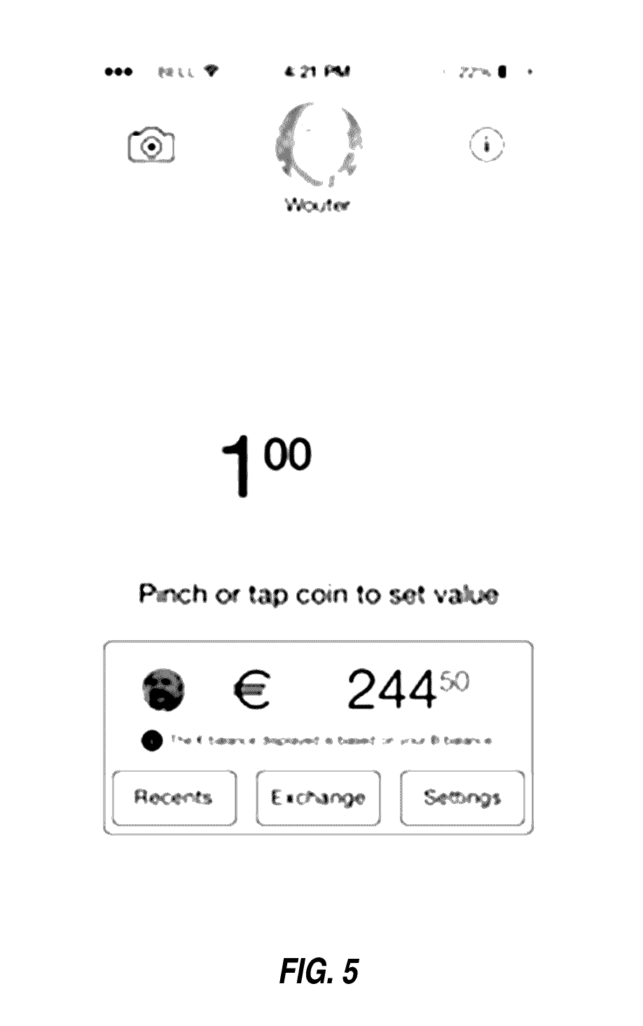

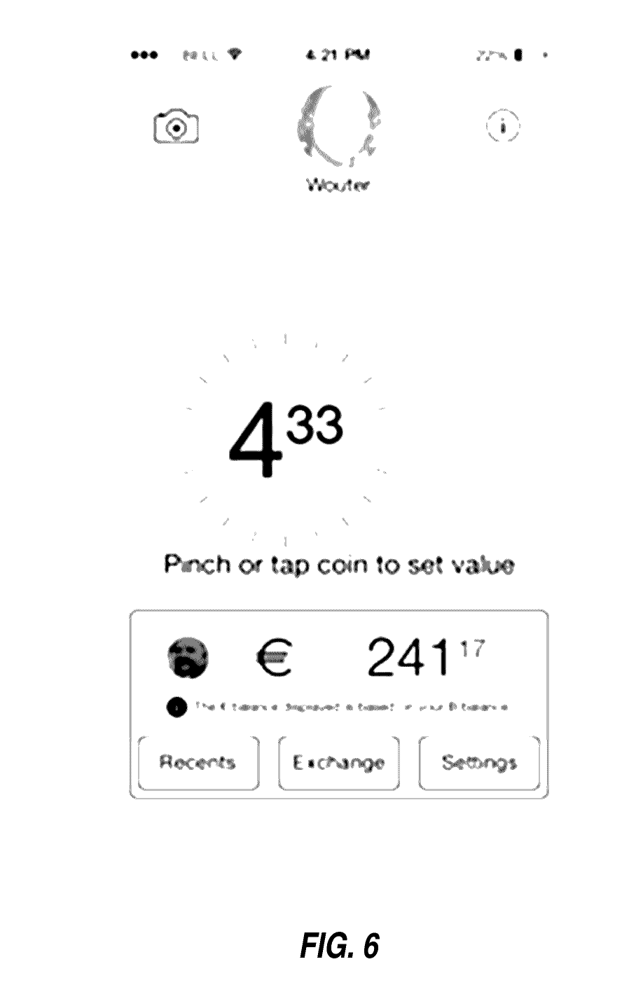

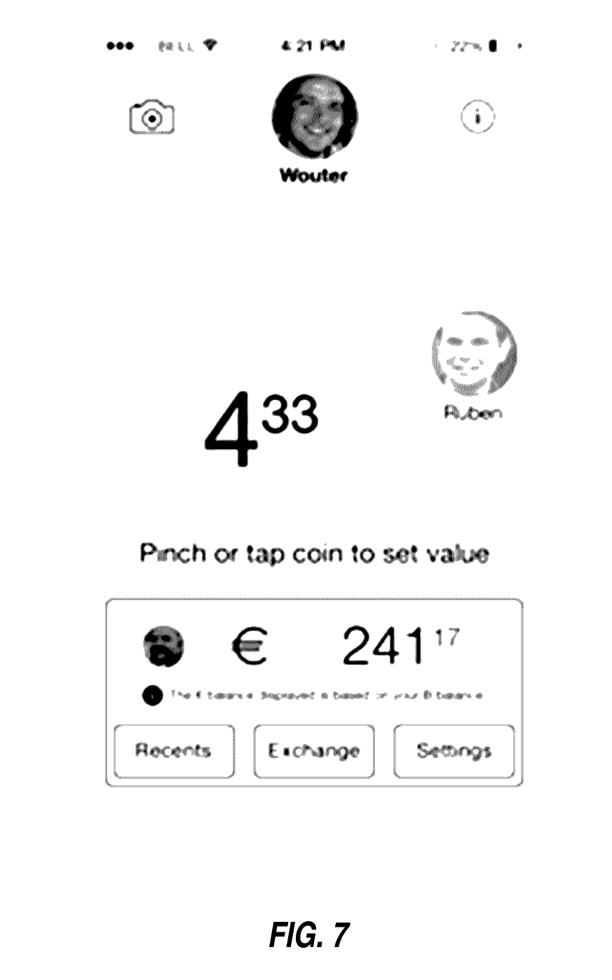

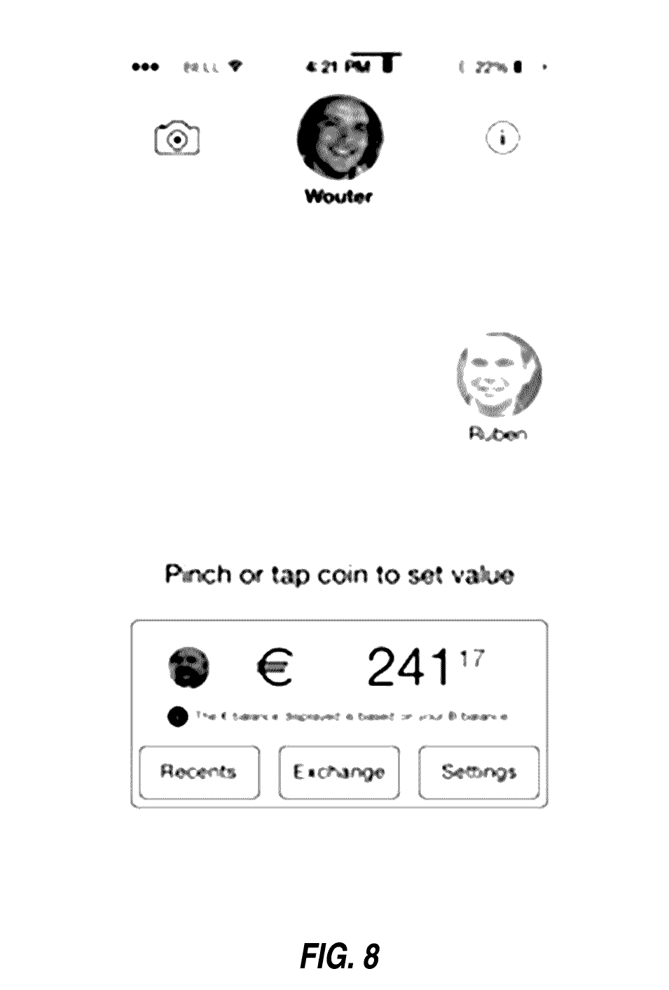

Next, user 50 shakes its phone 51 up to create an initial coin 72 from its balance 170, with an initial coin value as set in settings 126 by user 50 as shown in FIG. 5. The transaction amount is now determined by user 50 simply pinching coin 72 to a larger value and turning the dial to the exact decimal value for the transaction in FIG. 6. Tapping the avatar 71 of the other user 200 or merchant 240 to be paid is all it takes to complete the setup of the transaction 150 in FIG. 7. To authorize the payment 150, user 50 simply slides/swipes/swoops/shoots the coin 72 under the avatar 71 of the selected other user 200 or merchant 240 as shown in FIG. 8.

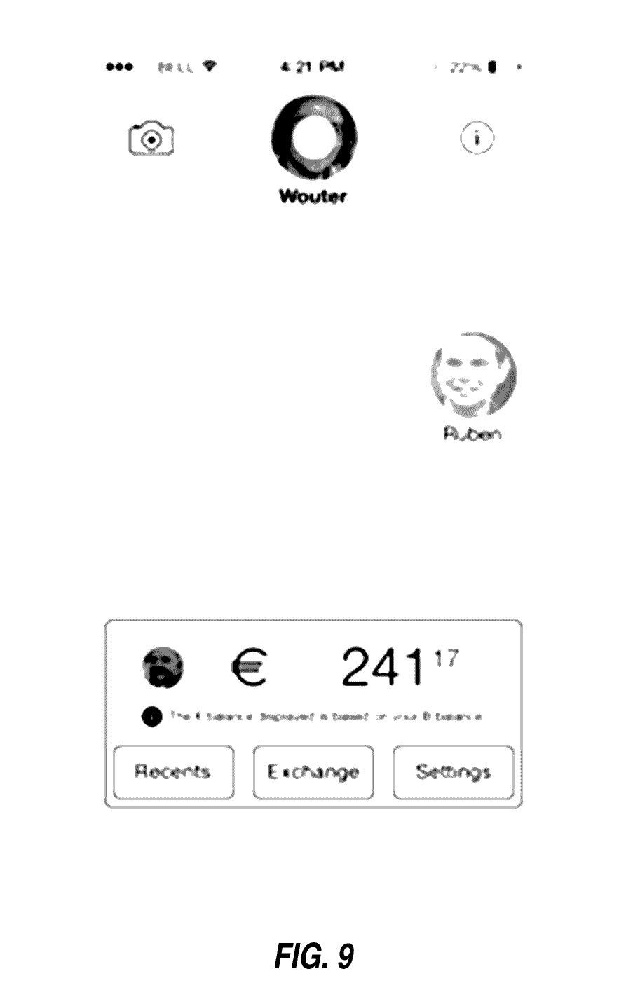

At this point, application 70 submits to the provider's 20 platform 21 through the electronic network 40, the payment transaction 150 details 151, including the beneficiary account ID 121 (existing user) or mobile number (non-user) and transaction amount in crypto currency. In case everything is OK, the virtual account 140 of user 50 is instantly debited for the transaction amount, and the beneficiary's virtual account 140 is instantly credited with the same amount (existing other user 200) or a text message is sent to the mobile number through a message service 195 (non-user), with the confirmation of the payment 150 to the selected other user 200 or merchant 240 visualized to user 50 in the avatar 71 picture in FIG. 9. In FIG. 10, confirmation of the payment 150 from user 50 is visualized to existing user 200 on the avatar 71, and with a coin 72 sliding into user's application 70. If something is not OK, the transaction 150 is cancelled and coin 72 simply slides back into user's 50 application 70 and nothing changes from the other user 200 or merchant 240.

Upon successful payment of a coin 72 by user 50 to an existing other user 200, the provider's 20 platform 21 sends a push notification through a message service 195 or similar technologies to instruct application 70 on user's 200 mobile phone 51 or merchant's 240 online channel 241 that a payment 150 has been made by user 50. Alternatively, Bluetooth 90 write technology, to which PM security may be added, may be used by user's 50 application 70 to directly instruct user's 200 application 70 or merchant's 240 Bluetooth beacon 241 that a payment 150 has been made. This results in a coin 72 with the paid 150 amount value sliding into user's 200 application 70, and user's 50 avatar 71 lighting up to indicate the origin of the payment 150.

Upon successful payment of a coin 72 by user 50 to a non-user, the provider's 20 platform 21 sends a text massage to contact 111 through a text message service 195 using the mobile number listed for the contact 111 in the address book 110 on user's 50 mobile phone 51. The contact 111 will receive the text message on its mobile phone 51 stating that it has received a payment 150 from user 50, and that the amount will be added to the balance 170 when it downloads and activates application 30 from an app store 60 and activates it with the same mobile number, within the stated period. If the contact 111 does not do so, the transaction is cancelled.

After the payment 150 has been successfully completed, user 50 will find the transaction details 151 in the transaction overview in application 70. User 50 may add a picture 152 and/or a message 153 to the transaction details 151 that will also appear in the transaction overview of the other user 200 or merchant 240.

Zero alpha-numeric data entry by a user, and no exchange of payment identifiers, credentials or authorization codes, yet end-to-end secured instant payments.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology disclosed herein and are intended to be covered by the following claims.

What is claimed is:

1. A computer-implemented method for end-to-end secured payments between users and other users or merchants, using only touch gestures and with no entry, storage, nor exchange of regulated payment system identifiers, credentials, or authorization codes, the method comprising:
providing a service provider platform having a computer, a database, and a mobile application, wherein the mobile application is accessible and downloadable over an electronic network;
downloading and utilizing, by a first user, the mobile application on a portable computing device having a processor, a display, a data storage area, and a wireless communication technology;
activating and configuring the mobile application for use by the first user;
discovering a second user;
presenting an icon, representing the second user, to the first user through the display of the mobile application;
selecting, by the first user, the second user to whom payment is to be made;
creating, by the first user, and using only touch gestures and with no entry, storage, nor exchange of regulated payment system identifiers, credentials, or authorization codes, a payment transaction to be made to the second user;
transmitting to the service provider platform the payment transaction for authorization;
debiting an account of the second user the payment transaction; and
notifying the first user, by the service provider platform, that the payment transaction is complete.

2. The method of claim 1, further comprising:
activating the mobile application for the first user, after downloading;
contacting, by the first user, the service provider platform via the electronic network;
creating a uniquely associated user account with an identification code;
assigning, by the service provider platform, an account identification code to the mobile application of the first user;
entering a mobile phone number and an email address for the first user;
verifying the entered mobile phone number and email address through an independent messaging channel;
setting a plurality of permissions for the mobile application to access system services;
creating a code, by the first user, for personal identification, and of which only a cryptographic equivalent is exchanged and stored; and
transmitting all data from the mobile application of the first user to the service provider platform to store in an account in the database.

3. The method of claim 1, further comprising:
configuring the mobile application for the first user; and
setting a user profile for the first user including a display name and an avatar for visual communication to a second user during the discovering step.

4. The method of claim 1, further comprising:
setting a display currency; and
converting all crypto currency values used by the mobile application into the display currency.

5. The method of claim 1, further comprising:
maintaining a virtual account for the first user at the service provider platform;
maintaining a crypto currency account with a crypto currency exchange;
maintaining a crypto currency balance with service provider platform; and
linking the virtual account and the crypto currency account.

6. The method of claim 1, wherein the step of discovering a second user comprises:
utilizing proximity detection technology and wireless communication technology.

7. The method of claim 1, wherein the step of discovering a second user comprises:
utilizing account QR codes; and
scanning by the first user an account QR code of the second user.

8. The method of claim 1, wherein the step of discovering a second user comprises:
utilizing an address book containing contacts; and
selecting by the first user a contact of the second user.

9. The method of claim 1, wherein the second user is a merchant.

10. A non-transitory computer readable storage medium encoded with programming for end-to-end secured payments between users and other users or merchants using only touch gestures, with no entry, storage, nor exchange of regulated payment system identifiers, credentials, or authorization codes, that when executed by a processor perform the steps comprising:
providing a service provider platform having a computer, a database, and a mobile application, wherein the mobile application is accessible and downloadable over an electronic network;
downloading and utilizing, by a first user, the mobile application on a portable computing device having a processor, a display, a data storage area, and a wireless communication technology;
activating and configuring the mobile application for use by the first user;
discovering a second user;
presenting an icon, representing the second user, to the first user through the display of the mobile application;
selecting, by the first user, the second user to whom payment is to be made;
creating, by the first user, and using only touch gestures and with no entry, storage, nor exchange of regulated payment system identifiers, credentials, or authorization codes, a payment transaction to be made to the second user;
transmitting to the service provider platform the payment transaction for authorization;
debiting an account of the second user the payment transaction; and
notifying the first user, by the service provider platform, that the payment transaction is complete.

11. The non-transitory computer readable storage medium of claim 10, that when executed by a processor perform the steps further comprising:
activating the mobile application for the first user, after downloading;
contacting, by the first user, the service provider platform via the electronic network;
creating a uniquely associated user account with an identification code;
assigning, by the service provider platform, an account identification code to the mobile application of the first user;
entering a mobile phone number and an email address for the first user;
verifying the entered mobile phone number and email address through an independent messaging channel;
setting a plurality of permissions for the mobile application to access system services;
creating a code, by the first user, for personal identification, and of which only a cryptographic equivalent is exchanged and stored; and
transmitting all data from the mobile application of the first user to the service provider platform to store in an account in the database.

12. The non-transitory computer readable storage medium of claim 10, that when executed by a processor perform the steps further comprising:
configuring the mobile application for the first user; and
setting a user profile for the first user including a display name and an avatar for visual communication to a second user during the discovering step.

13. The non-transitory computer readable storage medium of claim 10, that when executed by a processor perform the steps further comprising:
setting a display currency; and
converting all crypto currency values used by the mobile application into the display currency.

14. The non-transitory computer readable storage medium of claim 10, that when executed by a processor perform the steps further comprising:
maintaining a virtual account for the first user at the service provider platform;
maintaining a crypto currency account with a crypto currency exchange;
maintaining a crypto currency balance with service provider platform; and
linking the virtual account and the crypto currency account.

15. The non-transitory computer readable storage medium of claim 10, wherein the step of discovering a second user comprises:
utilizing proximity detection technology and wireless communication technology.

16. The non-transitory computer readable storage medium of claim 10, wherein the step of discovering a second user comprises:
utilizing account QR codes; and
scanning by the first user an account QR code of the second user.

17. The non-transitory computer readable storage medium of claim 10, wherein the step of discovering a second user comprises:
utilizing an address book containing contacts; and
selecting by the first user a contact of the second user.

18. The non-transitory computer readable storage medium of claim 10, wherein the second user is a merchant.

19. A system for end-to-end secured payments between users and other users or merchants using only touch gestures, with no entry, storage, nor exchange of regulated payment system identifiers, credentials, or authorization codes, the system comprising:
a service provider platform having a computer, a database, and a mobile application, wherein the mobile application is accessible and downloadable over an electronic network;
a portable computing device having a processor, a display, a data storage area, and a wireless communication technology, configured to download the mobile application for utilization by a first user;
wherein the processor is configured to run the mobile application in communication with the service provider platform and performs the steps comprising:
activating and configuring the mobile application for use by the first user;
discovering a second user;
presenting an icon, representing the second user, to the first user through the display of the mobile application;
selecting, by the first user, the second user to whom payment is to be made;
creating, by the first user, and using only touch gestures and with no entry, storage, nor exchange of regulated payment system identifiers, credentials, or authorization codes, a payment transaction to be made to the second user;
transmitting to the service provider platform the payment transaction for authorization;
debiting an account of the second user the payment transaction; and
notifying the first user, by the service provider platform, that the payment transaction is complete.

20. The system of claim 19,
wherein the processor is configured to run the mobile application and performs the steps further comprising:
activating the mobile application for the first user, after downloading;
contacting, by the first user, the service provider platform via the electronic network;
creating a uniquely associated user account with an identification code;
assigning, by the service provider platform, an account identification code to the mobile application of the first user;
entering a mobile phone number and an email address for the first user;
verifying the entered mobile phone number and email address through an independent messaging channel;
setting a plurality of permissions for the mobile application to access system services;
creating a code, by the first user, for personal identification, and of which only a cryptographic equivalent is exchanged and stored; and
transmitting all data from the mobile application of the first user to the service provider platform to store in an account in the database.
